(19) United States
(12) Patent Application Publication
(10) Pub. No.: US 2024/0270198 A1
(43) Pub. Date: Aug. 15, 2024

(54) BUCKLE DEVICE

(71) Applicant: KABUSHIKI KAISHA TOKAI-RIKA-DENKI-SEISAKUSHO, Aichi-ken (JP)

(72) Inventor: Ryuji YAMAGUCHI, Aichi (JP)

(73) Assignee: KABUSHIKI KAISHA TOKAI-RIKA-DENKI-SEISAKUSHO, Aichi-ken (JP)

(21) Appl. No.: 18/441,556

(22) Filed: Feb. 14, 2024

(30) Foreign Application Priority Data
Feb. 15, 2023 (JP) 2023-022014

(51) Int. Cl. B60R 22/18; A44B 11/25

(52) U.S. Cl. CPC B60R 22/18; A44B 11/2503; B60R 2022/1806

(57) ABSTRACT

In a buckle device, a buckle body is held in an upper part of a boot, and a lower part of the boot is supported from the lower side by a frame and a protector. Here, a left wall on a left side of the boot is fixed to the frame by a clip, and the fixing piece on the right side of the boot is fixed to the hook protrusion of the frame. Therefore, it is possible to suppress tilting of the boot to both sides in the right-left direction.

### CROSS-REFERENCE TO RELATED APPLICATION

This application is based on and claims priority under 35 USC 119 from Japanese Patent Application No. 2023-022014 filed on Feb. 15, 2023, the disclosure of which is incorporated by reference herein.

### BACKGROUND

### Technical Field

The present invention relates to a buckle device in which a holding member holds a buckle body and a support supports the holding member.

### Related Art

In the buckle device disclosed in Japanese Patent Application Laid-Open (JP-A) No. 2020-125010, a boot holds a buckle body and a protector, a cover, and a frame support the boot.

Here, in such a buckle device, it is preferable that tilting of the boot to both sides of the boot in a thickness direction can be suppressed.

### SUMMARY

In view of such circumstances, an object of the invention is to obtain a buckle device capable of suppressing tilting of a holding member to both sides in a thickness direction.

According to a first aspect of the invention, a buckle body configured to engage with a tongue provided at a webbing attached to an occupant; a holding member that holds the buckle body and is provided with fixing parts on both sides in a thickness direction; and a support that supports the holding member and to which both of the fixing parts are fixed.

In the buckle device according to the first aspect of the invention, the buckle body is configured to engage with the tongue provided at the webbing attached to the occupant. In addition, the holding member holds the buckle body, and the support supports the holding member.

Here, the fixing parts are provided on both sides of the holding member in the thickness direction, and both of the fixing parts are fixed to the support. Therefore, it is possible to suppress tilting of the holding member toward both sides in the thickness direction.

In a buckle device according to a second aspect of the invention, in the buckle device according to the first aspect of the invention, the fixing part is hooked on a side of the support opposite from the buckle body.

In the buckle device according to the second aspect of the invention, the fixing part is hooked on the side of the support opposite from the buckle body. Therefore, it is possible to effectively suppress detachment of the fixing part from the support.

A buckle device according to a third aspect of the invention in the buckle device according to the first or second aspect of the invention further includes a hook part that is provided at the support, and on which the fixing part is hooked, the hook part having a distal end side that protrudes to a distal end side of the fixing part.

In the buckle device according to the third aspect of the invention, the fixing part is hooked on the hook part of the support.

Here, the distal end side of the hook part protrudes toward the distal end side of the fixing part. Therefore, it is possible to effectively suppress detachment of the fixing part from the support.

A buckle device according to a fourth aspect of the invention in the buckle device according to any one of the first to third aspects of the invention further includes a hook part that is provided at the support and on which the fixing part is hooked, in which at least one of a thickness or a width of the fixing part on a distal end side of the hook part is increased.

In the buckle device according to the fourth aspect of the invention, the fixing part is hooked on the hook part of the support.

Here, at least one of the thickness or the width of the fixing part on the distal end side of the hook part is increased. Therefore, it is possible to easily hook the fixing part on the hook part.

A buckle device according to a fifth aspect of the invention in the buckle device according to any one of the first to fourth aspects of the invention further includes a hook part that is provided at the support and on which the fixing part is hooked, in which a protrusion is provided on the distal end side of the fixing part from the hook part.

In the buckle device according to the fifth aspect of the invention, the fixing part is hooked on the hook part of the support.

Here, the protrusion is provided on the distal end side of the fixing part from the hook part. Therefore, it is possible to easily hook the fixing part on the hook part.

A buckle device according to a sixth aspect of the invention in the buckle device according to any one of the first to fifth aspects of the invention further includes a mounting member that is provided at the support and is mounted to lock movement of the fixing part.

In the buckle device according to the sixth aspect of the invention, the mounting member of the support is mounted to lock the movement of the fixing part. Therefore, it is possible to regulate detachment of the fixing part from the support.

### BRIEF DESCRIPTION OF THE DRAWINGS

Exemplary embodiments of the present invention will be described in detail based on the following figures, wherein:

FIG. 1 is a cross-sectional view illustrating a buckle device according to a first embodiment of the invention as viewed from a rear;

FIG. 2A is a perspective view illustrating a main part of the buckle device according to the first embodiment of the invention as viewed from a diagonally front right;

FIG. 2B is a perspective view illustrating the main part of the buckle device according to the first embodiment of the invention as viewed from a diagonally bottom right;

FIG. 2C is a perspective view illustrating the main part of the buckle device according to the first embodiment of the invention as viewed from a diagonally rear bottom;

FIG. 3 is an exploded perspective view illustrating the main part of the buckle device according to the first embodiment of the invention as viewed from a diagonally front bottom;

FIG. 4 is a front view illustrating a frame, a boot, and the like of the buckle device according to the first embodiment of the invention as viewed from a front;

FIG. 5 is a perspective view illustrating the boot of the buckle device according to the first embodiment of the invention as viewed from a diagonally front right;

FIG. 6A is a perspective view illustrating a buckle device according to a modification example of the first embodiment of the invention as viewed from the diagonally bottom right;

FIG. 6B is a bottom view illustrating the buckle device according to the modification example of the first embodiment of the invention as viewed from a bottom;

FIG. 7 is a perspective view illustrating a buckle device according to a second embodiment of the invention as viewed from the diagonally front bottom;

FIG. 8A is a right side view illustrating the buckle device according to the second embodiment of the invention as viewed from the right;

FIG. 8B is a cross-sectional view illustrating the buckle device according to the second embodiment of the invention as viewed from the rear; and

FIG. 9 is a perspective view illustrating a buckle device according to a third embodiment of the invention as viewed from the diagonally front right.

### DETAILED DESCRIPTION

### [FIRST EMBODIMENT]

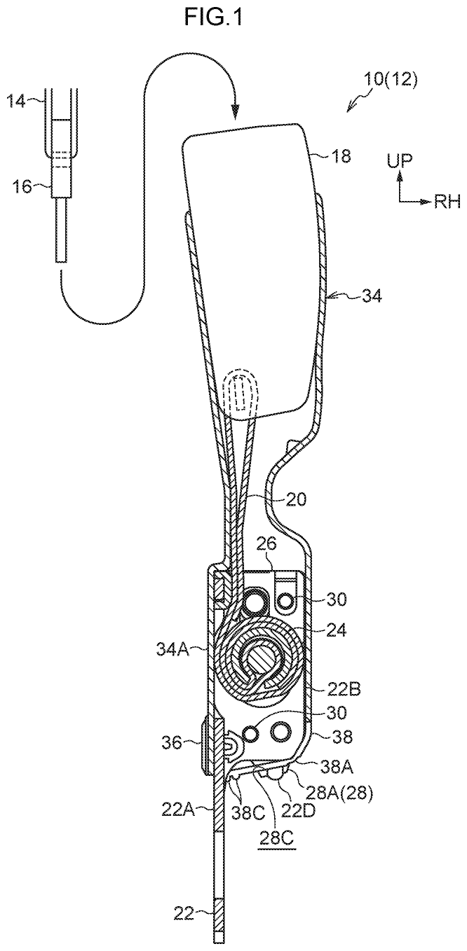

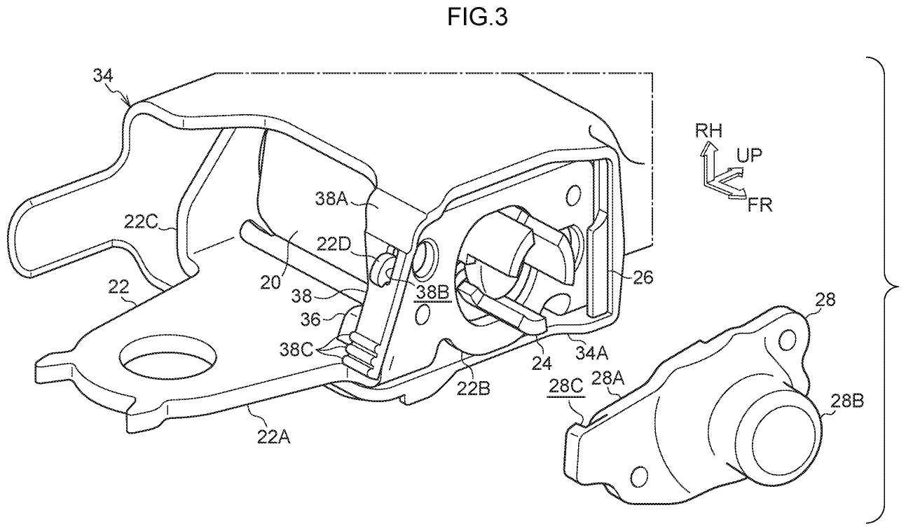

FIG. 1 is a cross-sectional view of a buckle device 10 according to a first embodiment of the invention as viewed from the rear. FIG. 3 is an exploded perspective view illustrating a main part of the buckle device 10 as viewed from the diagonally front bottom. In the drawings, the front of the buckle device 10 is indicated by an arrow FR, the right (obverse side) of the buckle device 10 is indicated by an arrow RH, and the upper side of the buckle device 10 is indicated by an arrow UP.

The buckle device 10 according to the present embodiment constitutes a seat belt device 12 of a vehicle (automobile). The seat belt device 12 is applied to a seat (not illustrated) in a vehicle interior. The seat belt device 12 is provided with a winding device (not illustrated). The winding device is installed on the vehicle width direction outer side and the lower side of a seat rear part. In the winding device, a webbing 14 (see FIG. 1) having a long band shape is wound from the proximal end side. A webbing 14 is biased to the winding side to the winding device and pulled out upward from the winding device. The winding device is provided with a lock mechanism, and the lock mechanism locks pulling-out of the webbing 14 from the winding device in an emergency of the vehicle (in collision or the like).

The webbing 14 passes through a through anchor (not illustrated) movably on the distal end side with respect to the winding device. The through anchor is installed on the vehicle width direction outer side and the upper side of the seat rear part. An anchor (not illustrated) is fixed to the distal end part of the webbing 14, and the anchor is installed on the vehicle width direction outer side and the lower side of the seat rear part. The webbing 14 movably passes through a tongue 16 (see FIG. 1) between the through anchor and the anchor.

The buckle device 10 is installed on the vehicle width direction inner side and the lower side of the seat rear part. The front, the right, and the upper side of the buckle device 10 are directed toward the front side or the rear side, and directed inward in the vehicle width direction, and directed upward, respectively.

As illustrated in FIG. 1, a buckle body 18 having a substantially rectangular parallelepiped shape is provided at an upper part of the buckle device 10. The tongue 16 is engageable with the buckle body 18 from the upper side. The tongue 16 is engaged with the buckle body 18, and the webbing 14 is attached to an occupant seated on the seat. As a result, a part (shoulder webbing) of the webbing 14 between the through anchor and the tongue 16 is stretched obliquely from the shoulder part to the waist part (including the chest part) of the occupant, and a part (wrap webbing) of the webbing 14 between the tongue 16 and the anchor is stretched laterally to the waist part of the occupant. The engagement of the tongue 16 with the buckle body 18 is releasable. The engagement of the tongue 16 with the buckle body 18 is released to release the attachment of the webbing 14 to the occupant. The lower side part of the buckle body 18 gradually becomes smaller downward in the right-left direction.

A distal-end side part (upper side part) of a band-shaped belt 20 (webbing) as a coupling member is coupled to the lower part of the buckle body 18. The belt 20 is made of, for example, the same material as the material of the webbing 14 and made into a woven fabric.

As illustrated in FIGS. 1 and 3, a frame 22 that is made of metal as a support member constituting a support is provided in a lower part of the buckle device 10, and the frame 22 is made to have a U-shaped plate shape in a cross section. A back plate 22A is provided at a left part of the frame 22. The frame 22 is fixed to a vehicle body side (for example, a rear part of a seat lower part) at a lower end part of the back plate 22A. Leg plates 22B and 22C are provided at the front part and the rear part of the frame 22, respectively. The leg plates 22B and 22C protrude rightward from the back plate 22A. A hook protrusion 22D having an L-shaped plate shape as a hook part is integrally formed at the right part of the lower surface of the leg plate 22B. The hook protrusion 22D protrudes downward and has a distal end part (lower end part) that protrudes leftward.

A spool 24 that is made of metal and has a substantially cylindrical shape as a winding shaft passes through the leg plates 22B and 22C of the frame 22. The spool 24 is supported by the frame 22. The axial direction of the spool 24 is parallel to the front-rear direction, and the spool 24 is made rotatable about the central axis. A proximal-end side part (lower side part) of the belt 20 is coupled to the spool 24. The belt 20 is wound around the spool 24 and pulled out upward from the left side of the spool 24.

A protector 26 made of resin as a covering member constituting the support is fitted into an upper part of the frame 22. The protector 26 is made to have a U-shape in top view. The inside of the protector is opened to the right side, and the left wall, the front wall, and the rear wall of the protector 26 cover the back plate 22A, the leg plate 22B, and the leg plate 22C of the frame 22, respectively. The upper end part of the protector 26 protrudes to the outside of the protector 26, and the upper end part of the protector 26 is placed on the upper side of the frame 22. The belt 20 is inserted into the protector 26, and the protector 26 restricts the contact of the belt 20 with the frame 22.

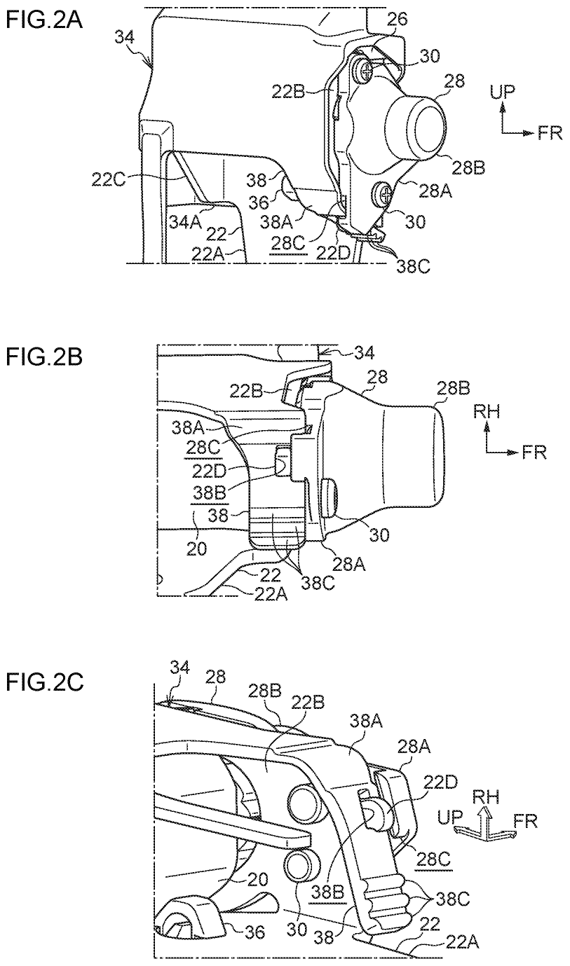

A case 28 (see FIGS. 2A, 2B, and 2C) that is made of metal as a mounting member constituting the support is disposed on the front side of the frame 22 (leg plate 22B). The case 28 is provided with a locking plate 28A having a substantially rectangular plate shape. The case 28 is mounted to the leg plate 22B by fixing the upper part and the lower part of the locking plate 28A to the leg plate 22B with screws 30. A locking hole 28C having a rectangular cross section as a locking part is formed at the lower end part of the locking plate 28A, and the locking hole 28C is opened rearward. The locking hole 28C extends in a downward direction as being directed leftward. Both ends of the locking hole 28C in the longitudinal direction are opened. A locking cylinder 28B having a substantially bottomed cylindrical shape is integrally formed on the front side of the locking plate 28A. The axial direction of the locking cylinder 28B is parallel to the front-rear direction. The inside of the locking cylinder 28B penetrates the locking plate 28A and is opened to the rear side of the locking plate 28A. The front part of the spool 24 is coaxially inserted into the case 28.

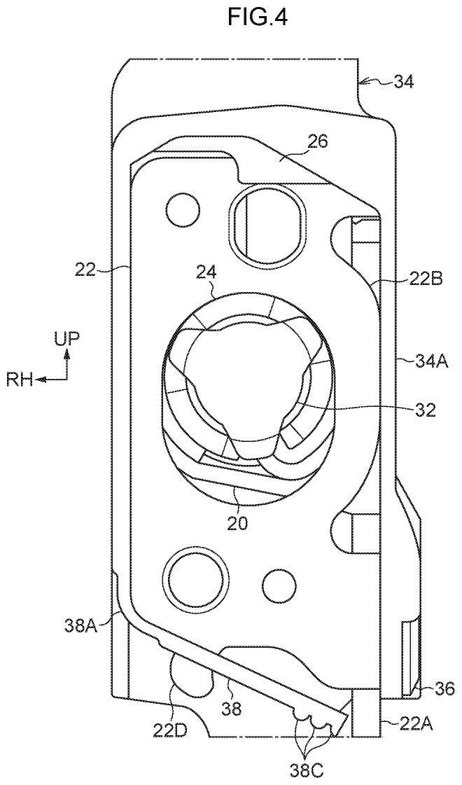

A torsion shaft 32 (see FIG. 4) that is made of metal and has a substantially circular columnar shape as a deformation member (energy absorbing member) is coaxially disposed in the case 28. The front end part of the torsion shaft 32 is locked to the front end part in the locking cylinder 28B in a relatively non-rotatable manner. The rear end part of the torsion shaft 32 is coupled to the spool 24 in a relatively non-rotatable manner to restrict the rotation of the spool 24.

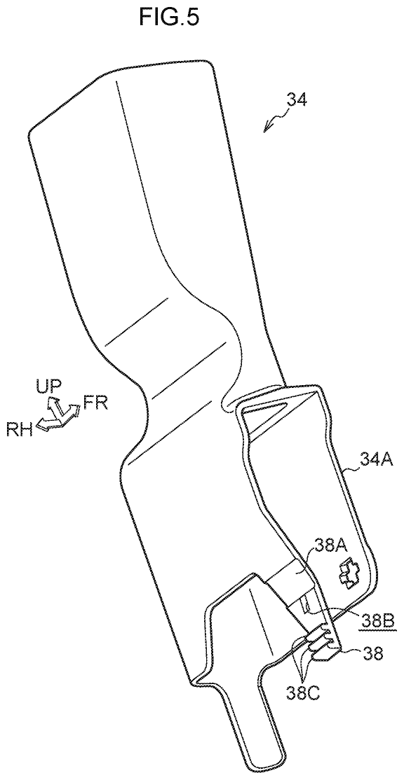

A boot 34 (see FIG. 5) having a substantially rectangular cylindrical shape as a holding member is provided in a range from the buckle body 18 to the frame 22. The boot 34 is made of soft resin and has flexibility (elasticity). In the boot 34, the axial direction is set to be the up-down direction, and a dimension in the right-left direction is smaller than a dimension in the front-rear direction. A thickness direction of the boot 34 is set to be the right-left direction.

The upper part of the boot 34 gradually becomes smaller downward in the right-left direction. The boot 34 holds the buckle body 18 in a manner such that the lower side part of the buckle body 18 is fitted into the upper part of the boot 34 to restrict the downward movement of the buckle body 18. The belt 20 is inserted into the boot 34, and the frame 22 (including the spool 24) and the protector 26 are inserted into the lower part of the boot 34. The inside of the lower part of the boot 34 is opened to the front side, and the case 28 protrudes to the front side of the lower part of the boot 34. Just above the lower part in the boot 34 is supported by the protector 26 and the frame 22 from the lower side, which restricts the downward movement of the boot 34. An elastic contraction force is applied to the boot 34 between the buckle body 18 and the protector 26 in a state where the belt 20 is wound around the spool 24 as described above, and thus the tension is applied to the belt 20. The boot 34 biases the protector 26 and the frame 22 downward to be self-standing with respect to the protector 26 and the frame 22 and biases the buckle body 18 upward to be self-standing.

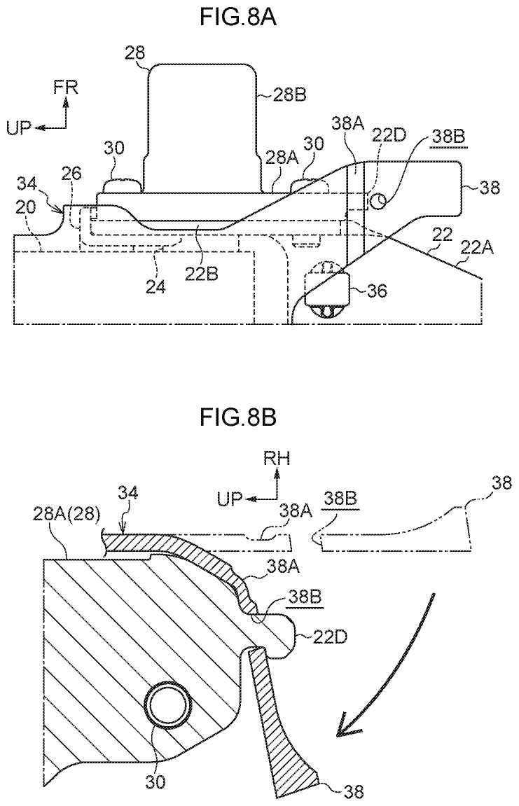

A clip 36 (see FIG. 8) that is made of hard resin and has a substantially columnar shape as a fixing member passes through a lower end part of the left wall 34A of the boot 34 as the fixing part and the back plate 22A of the frame 22. A proximal end (left end) of the clip 36 is made in a substantially elliptical plate shape, and a distal end part (right end part) of the clip 36 is formed in a substantially trapezoidal columnar shape. The axial direction of the distal end part of the clip 36 is set to be the front-rear direction, and the distal end part of the clip 36 protrudes upward and downward. After the distal end part of the clip 36 is temporarily elastically reduced in the up-down direction and passes through the left wall 34A of the boot 34 and the back plate 22A of the frame 22, the distal end part is caused to pass through the left wall 34A and the back plate 22A to be elastically expanded (elastically restored) in the up-down direction. Therefore, the left wall 34A of the boot 34 and the back plate 22A of the frame 22 are sandwiched between the proximal end and the distal end part of the clip 36, and the left wall 34A of the boot 34 is fixed to the back plate 22A of the frame 22 by the clip 36.

A fixing piece 38 (see FIGS. 2A, 2B, 2C, and 4) having a long plate shape as a fixing part is integrally formed at a front end part of the right wall of the boot 34, and the fixing piece 38 is extended downward. A thin part 38A is formed at a proximal end part of the fixing piece 38, and elastic bending performance and elastic stretching performance of the fixing piece 38 are enhanced in the thin part 38A. The fixing piece 38 is bent leftward along the lower and right corner part of the leg plate 22B of the frame 22 at the thin part 38A, and a part of the fixing piece 38 on the distal end side from the thin part 38A is extended in a downward direction as being directed rightward.

A hook hole 38B having an elongated rectangular shape as a hooking target part is formed to penetrate an intermediate part (intermediate part in the longitudinal direction) of the fixing piece 38, and the hook hole 38B is extended in the longitudinal direction of the fixing piece 38. The hook protrusion 22D of the leg plate 22B passes through the hook hole 38B. The left surface of the hook hole 38B approaches or abuts on a proximal-end side part of the hook protrusion 22D, and the hook protrusion 22D is fitted to the hook hole 38B in the front-rear direction. The distal-end side part of the fixing piece 38 from the hook hole 38B can abut on the distal end part of the hook protrusion 22D, and the downward movement of the distal-end side part of the fixing piece 38 from the hook hole 38B is restricted by the distal end part of the hook protrusion 22D. As a result, the fixing piece 38 (hook hole 38B) is hooked on the hook protrusion 22D.

The intermediate part of the fixing piece 38 is inserted into the locking hole 28C of the case 28 (locking plate 28A) in a part including the front side part from the hook hole 38B, and the lower surface of the locking hole 28C locks the downward movement of the intermediate part of the fixing piece 38. A part of the locking plate 28A below the locking hole 28C approaches or abuts on the hook protrusion 22D of the leg plate 22B. Thus, the fixing piece 38 is fixed to the frame 22.

A predetermined number (three in the present embodiment) of protruding parts 38C having a semi-columnar shape as protrusions are integrally formed at the distal end part of the fixing piece 38, and the protruding part 38C protrudes downward to increase the thickness of the fixing piece 38 and is extended in the front-rear direction. The predetermined number of protruding parts 38C are arranged in the longitudinal direction of the fixing piece 38, and a gap is provided between the protruding parts 38C.

Next, the action of the embodiment will be described.

In the seat belt device 12 having the above configuration, in the buckle device 10, the torsion shaft 32 restricts the rotation of the spool 24 to restrict the pull-out of the belt 20 from the spool 24 and the upward extension of the buckle body 18, and the webbing 14 is attached to the occupant by engaging the tongue 16 of the webbing 14 with the buckle body 18.

At the time of collision of the vehicle (in emergency), the locking mechanism of the winding device locks the pulling-out of the webbing 14 from the winding device, whereby the occupant is restrained by the webbing 14. For example, in a case in which an inertial force is applied to the occupant and the webbing 14 is pulled by the occupant, a pulling force from the spool 24 is applied to the belt 20 from the webbing 14 via the tongue 16 and the buckle body 18, whereby a rotational force is applied to the spool 24. The torsion shaft 32 is deformed to be twisted (plastically deformed) between the front end part and the rear end part by the rotational force applied to the spool 24, and the rotation of the spool 24 is allowed, so that the belt 20 is allowed to be pulled out from the spool 24 and the buckle body 18 (including the tongue 16) is allowed to extend upward. Therefore, a load applied from the webbing 14 to the occupant (particularly, the chest part) is reduced (restricted to a load (force limiter load) twisted deformation of the torsion shaft 32), and kinetic energy of the occupant is absorbed by twisted deformation of the torsion shaft 32, whereby the occupant is protected.

The buckle body 18 is held in the upper part of the boot 34. The frame 22 and the protector 26 are inserted into the lower part of the boot 34, and the boot 34 is supported by the frame 22 and the protector 26 from the lower side.

Here, the left wall 34A and the fixing piece 38 are provided on the left side and the right side (both sides in the thickness direction) of the boot 34, respectively. The lower end part of the left wall 34A is fixed to the back plate 22A of the frame 22 by the clip 36. The fixing piece 38 (hook hole 38B) is hooked on the hook protrusion 22D of the frame 22 (leg plate 22B), and the fixing piece 38 is inserted into the locking hole 28C of the case 28 (locking plate 28 A), whereby the fixing piece 38 is fixed to the frame 22. Therefore, for example, even in a case in which a load is input to the upper side part of the boot 34 from the occupant, it is possible to suppress rightward tilting of the boot 34 by fixing the left wall 34A of the boot 34 to the frame 22, and it is possible to suppress leftward tilting of the boot 34 by fixing the fixing piece 38 to the frame 22. It is possible to suppress tilting of the boot 34 to both sides in the right-left direction.

The fixing piece 38 (hook hole 38B) of the boot 34 is hooked on the hook protrusion 22D on a side of the frame 22 (leg plate 22B) opposite from (lower side) the buckle body 18. Therefore, as compared with a case where the boot 34 is hooked to the right side of the frame 22 (leg plate 22B), it is possible to increase the amount of elastic stretching of the boot 34 due to leftward tilting of the boot 34 and to effectively suppress the detachment of the fixing piece 38 (hook hole 38B) from the hook protrusion 22D.

The distal end part of the hook protrusion 22D protrudes toward the distal end side (left side) of the fixing piece 38. Therefore, it is possible to restrict the downward movement of the fixing piece 38 by the distal end part of the hook protrusion 22D, and to effectively suppress the detachment of the fixing piece 38 (hook hole 38B) from the hook protrusion 22D.

Further, the fixing piece 38 is inserted into the locking hole 28C of the case 28 (locking plate 28A), and the lower surface of the locking hole 28C locks the downward movement of the fixing piece 38. Therefore, it is possible to effectively restrict the downward movement of the fixing piece 38 and to effectively suppress the detachment of the fixing piece 38 (hook hole 38B) from the hook protrusion 22D.

In addition, the thin part 38A is provided on the proximal end side of the fixing piece 38 from the hook hole 38B, and the elastic stretching performance of the thin part 38A is enhanced. Therefore, in a case in which the fixing piece 38 (hook hole 38B) is hooked on the hook protrusion 22D, the fixing piece 38 can be favorably elastically stretched in the thin part 38A, and the fixing piece 38 (hook hole 38B) can easily pass through the distal end part of the hook protrusion 22D. After the fixing piece 38 (hook hole 38B) passes through the distal end part of the hook protrusion 22D, the fixing piece 38 can be favorably elastically contracted (elastically restored) in the thin part 38A, and thus it is possible to restrict the downward movement of the fixing piece 38 by the distal end part of the hook protrusion 22D.

The protruding part 38C is provided at the distal end part of the fixing piece 38, and the thickness of the distal end part of the fixing piece 38 is increased in the protruding part 38C. Therefore, in a case in which the fixing piece 38 (hook hole 38B) is hooked on the hook protrusion 22D, it is possible to favorably grip the distal end of the fixing piece 38, and to easily hook the fixing piece 38 (hook hole 38B) on the hook protrusion 22D.

### (MODIFICATION EXAMPLE)

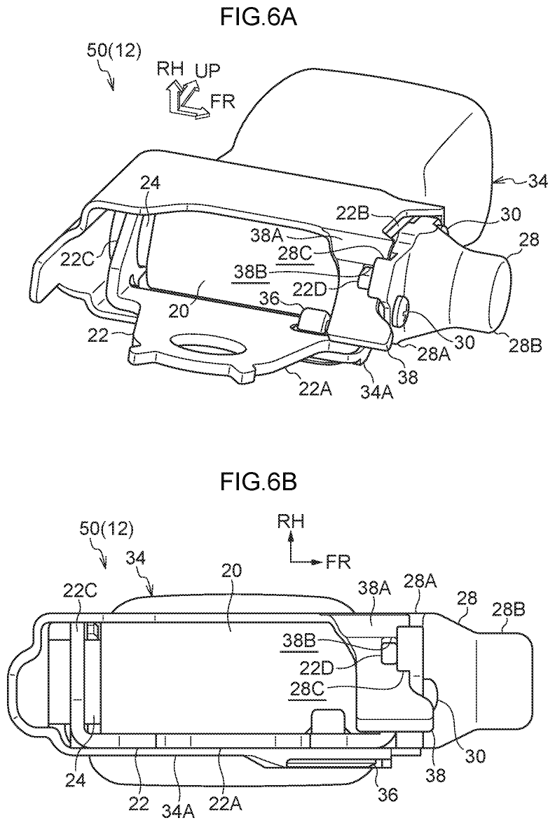

FIG. 6A is perspective view illustrating a buckle device 50 according to a modification example of the first embodiment as viewed from the diagonally bottom right. FIG. 6B is a bottom view illustrating the buckle device 50 as viewed from the bottom.

As illustrated in FIGS. 6A and 6B, in the buckle device 50 according to the present modification example, the protruding part 38C is not provided at the distal end part of the fixing piece 38 of the boot 34, and the thickness of the distal end part of the fixing piece 38 is gradually increased downward as being directed toward the distal end side and increased forward. Therefore, in a case in which the fixing piece 38 (hook hole 38B) is hooked on the hook protrusion 22D of the frame 22 (leg plate 22B), it is possible to favorably grip the distal end part of the fixing piece 38.

Here, also in the modification example, it is possible to exhibit the similar actions and effects to those of the first embodiment.

### [SECOND EMBODIMENT]

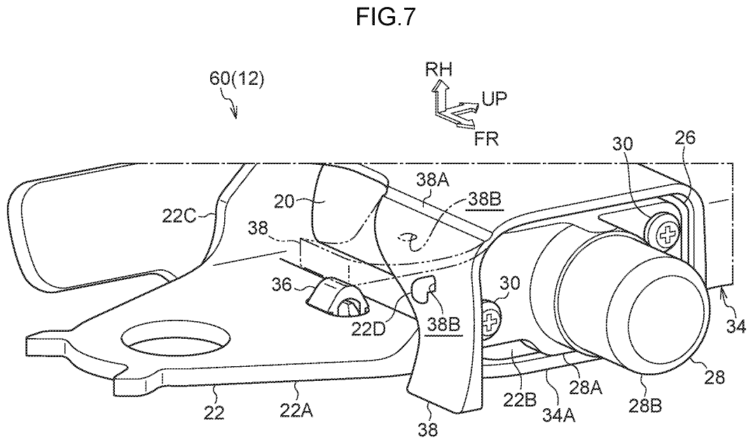

FIG. 7 is a perspective view illustrating a buckle device 60 according to a second embodiment of the invention as viewed from the diagonally front bottom.

The buckle device 60 according to the present embodiment has substantially the similar configuration to the configuration of the modification example of the first embodiment, but differs in the following points.

As illustrated in FIG. 7, in the buckle device 60 according to the embodiment, the locking hole 28C is not formed in the lower end part of the locking plate 28A in the case 28, and the hook protrusion 22D is integrally formed on the lower surface of the locking plate 28A instead of the frame 22 (see FIG. 8B).

In the fixing piece 38 (see FIGS. 8A and 8B) of the boot 34, the hook hole 38B is made in a circular shape. The diameter dimension of the hook hole 38B is substantially equal to the thickness dimension of the hook protrusion 22D, and is smaller than the width dimension of the proximal-end side part of the hook protrusion 22D. The proximal-end side part of the hook protrusion 22D penetrates and is press-fitted into the hook hole 38B, and the distal-end side part of the fixing piece 38 from the hook hole 38B is made to allow abutting on the distal end portion of the hook protrusion 22D, whereby the downward movement is restricted by the distal end portion of the hook protrusion 22D. As a result, the fixing piece 38 (hook hole 38B) is hooked on the hook protrusion 22D, and thus the fixing piece 38 is fixed to the case 28. The distal end part of the fixing piece 38 is not enlarged to the front side.

Here, also in the embodiment, it is possible to exhibit the similar actions and effects to those of the first embodiment.

In particular, the proximal-end side part of the hook protrusion 22D of the case 28 (locking plate 28A) is press-fitted into the hook hole 38B of the fixing piece 38 of the boot 34. Therefore, it is possible to effectively restrict the downward movement of the fixing piece 38 and to effectively suppress the detachment of the fixing piece 38 (hook hole 38B) from the hook protrusion 22D.

### [THIRD EMBODIMENT]

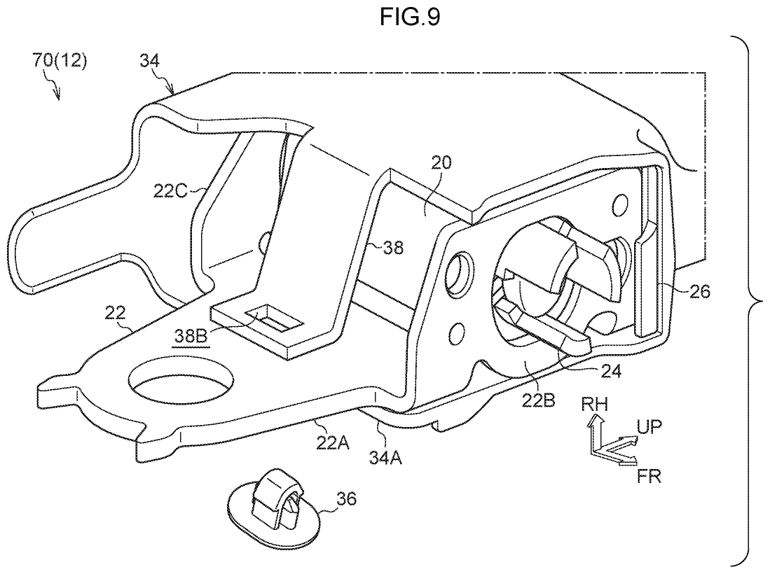

FIG. 9 is a perspective view illustrating a buckle device 70 according to a third embodiment of the invention as viewed from the diagonally front right.

The buckle device 70 according to the present embodiment has substantially the similar configuration to the configuration of the first embodiment, but differs in the following points.

As illustrated in FIG. 9, in the buckle device 70 according to the present embodiment, the frame 22 (leg plate 22B) is not provided with the hook protrusion 22D, and the locking hole 28C is not formed at the lower end part of the locking plate 28A of the case 28.

The fixing piece 38 is integrally formed at the intermediate part of the right wall of the boot 34 in the front-rear direction. The fixing piece 38 is not provided with the thin part 38A at the proximal end part and is not provided with the protruding part 38C at the distal end part. The proximal end part of the fixing piece 38 is bent leftward, and a rectangular hook hole 38B is formed to penetrate the distal end part of the fixing piece 38.

The clip 36 passes through the lower end part of the left wall 34A of the boot 34, the back plate 22A of the frame 22, and the hook hole 38B of the fixing piece 38. After the distal end part of the clip 36 is temporarily elastically reduced in the up-down direction and passes through the left wall 34A of the boot 34, the back plate 22A of the frame 22, and the hook hole 38B of the fixing piece 38, the distal end part is caused to pass through the left wall 34A, the back plate 22A, and the hook hole 38B to be elastically enlarged (elastically restored) in the up-down direction. Therefore, the left wall 34A of the boot 34, the back plate 22A of the frame 22, and the fixing piece 38 are sandwiched between the proximal end and the distal end part of the clip 36, and the left wall 34A of the boot 34 and the fixing piece 38 are fixed to the back plate 22A of the frame 22 by the clip 36.

Here, also in the embodiment, it is possible to exhibit the similar actions and effects to those of the first embodiment except for the action and effect obtained by the thin part 38A of the fixing piece 38 and the action and effect obtained by the protruding part 38C of the fixing piece 38.

In the embodiment, the left wall 34A of the boot 34 and the fixing piece 38 are fixed together to the frame 22 by the clip 36. The left wall 34A of the boot 34 and the fixing piece 38 may be separately fixed to the frame 22 (support).

In the first and second embodiments, one hook protrusion 22D is provided in the frame 22 or the case 28 (support), and one hook hole 38B is provided in the boot 34 (fixing piece 38). A plurality of hook protrusions 22D may be provided in the frame 22 or the case 28 (support), and a plurality of hook holes 38B may be provided in the boot 34 (fixing piece 38).

Furthermore, in the first to third embodiments, the boot 34 and the clip 36 are made to be separated from each other. The boot 34 and the clip 36 may be integrally made. In this case, the boot 34 and the clip 36 may be separated in a case in which the boot 34 is fixed to the frame 22 (support) by the clip 36.

In the first to third embodiments, the spool 24 is provided in the frame 22. The belt 20 may be coupled to the frame 22 without providing the spool 24 in the frame 22. In this case, the torsion shaft 32 does not need to be provided.

What is claimed is:

1. A buckle device comprising:
a buckle body configured to engage with a tongue provided at a webbing attached to an occupant;
a holding member that holds the buckle body and is provided with fixing parts on both sides in a thickness direction; and
a support that supports the holding member and to which both of the fixing parts are fixed.

2. The buckle device according to claim 1, wherein the fixing part is hooked on a side of the support opposite from the buckle body.

3. The buckle device according to claim 1, further comprising: a hook part that is provided at the support, on which the fixing part is hooked, the hook part having a distal end side protruding to a distal end side of the fixing part.

4. The buckle device according to claim 1, further comprising: a hook part that is provided at the support, and on which the fixing part is hooked, wherein at least one of a thickness or a width of the fixing part on a distal end side from the hook part is increased.

5. The buckle device according to claim 1, further comprising: a hook part that is provided at the support and on which the fixing part is hooked, wherein a protrusion is provided on a distal end side of the fixing part from the hook part.

6. The buckle device according to claim 1, further comprising: a mounting member that is provided at the support and is mounted to lock movement of the fixing part.

7. The buckle device according to claim 1, wherein the fixing part is extended from the holding member, and elasticity of the fixing part at a proximal end side from a fixing portion to the support is larger.

8. The buckle device according to claim 1, wherein the fixing part is fixed to the support by press-fitting.

9. The buckle device according to claim 1, wherein both of the fixing parts are fixed to one side of the support in a holding-member thickness direction.

10. The buckle device according to claim 1, further comprising: a fixing member that fixes both of the fixing parts to the support.
